(19) United States
(12) Patent Application Publication
(10) Pub. No.: US 2021/0222792 A1
(43) Pub. Date: Jul. 22, 2021

(54) BUTTERFLY VALVE LOCKING MECHANISM AND BUTTERFLY VALVE INCORPORATING THE SAME

(71) Applicant: Spartan Pumps Inc., Odessa, TX (US)

(72) Inventors: Ben Liu, Sugar Land, TX (US); Zujia Liu, Odessa, TX (US); John W. Beene, Odessa, TX (US)

(21) Appl. No.: 16/810,416

(22) Filed: Mar. 5, 2020

Related U.S. Application Data
(60) Provisional application No. 62/964,468, filed on Jan. 22, 2020.

(51) Int. Cl. F16K 35/02; F16K 1/22

(52) U.S. Cl. CPC F16K 35/025; F16K 1/221

(57) ABSTRACT

A valve locking mechanism, comprising: a handle configured to rotate about a rotation axis; a position plate comprising a plurality of locking holes positioned about an outer circumferential edge of the position plate, the plurality of locking holes spaced apart from each other in a rotational direction of the handle, each of the plurality of locking holes completely surrounded by the position plate; a locking lever pivotally connected to the handle about a connection point and configured to move between a locked position and an unlocked position, the locking lever including a locking stud mounted to the locking lever and configured to engage any one of the plurality of locking holes when the locking lever is in the locked position; and a spring to bias the locking lever toward the locked position. In the locked position, the handle is locked at a rotation position corresponding to the engaged locking hole.

### CROSS-REFERENCE TO RELATED APPLICATIONS

This application claims benefit of U.S. Provisional Application No. 62/964,468, filed Jan. 22, 2020, entitled BUTTERFLY VALVE LOCKING MECHANISM AND BUTTERFLY VALVE INCORPORATING THE SAME (Atty. Dkt. No. SPAR02-00002), the specification of which is incorporated by reference herein in its entirety.

### TECHNICAL FIELD

The disclosure relates to a locking mechanism for valves and valves incorporating such mechanisms.

### BACKGROUND

Butterfly valves are used to isolate or regulate the flow of a fluid in a system. Butterfly valves include a disk positioned in a center of a pipe of the butterfly valve. The disk can rotate between opened or closed positions to control the isolation or flow of fluid through the system. The rotation of the disk is controlled by a handle outside of the valve, connected to the disk by a stem. As the handle is rotated the disk is also rotated by the stem to position the disk in a desired position.

A locking mechanism can be used to lock the handle in a position related to a desired position of the disk. Traditionally, locking mechanisms have used a locking lever with an engagement tooth to engage with a slotted position plate in order to keep handle in the desired position. The slots of the locking plate are defined by spaced-apart tabs. The tabs of the position plate are prone to failure in securely engaging the engagement tooth for a number of reasons. The slots have sharp corners which lead to stress concentration. Because the tabs of the slots extend from an outer circumference of the position plate, the tabs are prone to break off due to repeated stress. Further, the engagement tooth can wear down the tabs over time. The failure of the tabs lead to misshapen slots that cannot properly secure the engagement tooth and ultimately lead to a failure in being able to secure the position of the disk of the butterfly valve.

### SUMMARY

It is an aspect of the disclosure to provide a valve locking mechanism, comprising: a handle configured to rotate about a rotation axis; a position plate positioned on the rotation axis, the position plate comprising a plurality of locking holes positioned about an outer circumferential edge of the position plate, the plurality of locking holes spaced apart from each other in a rotational direction of the handle, each of the plurality of locking holes completely surrounded by the position plate; a locking lever pivotally connected to the handle about a connection point, the locking lever configured to move between a locked position and an unlocked position, the locking lever including a locking stud mounted to the locking lever, the locking stud proximate to the position plate and configured to engage any one of the plurality of locking holes when the locking lever is in the locked position; and a spring engaging the locking lever to bias the locking lever toward the locked position in a natural state. When the locking lever is in the locked position, the handle is locked at a rotation position corresponding to the one of the plurality of locking holes engaged by the locking stud.

It is an aspect of the disclosure to provide a valve locking mechanism, wherein the handle comprises a safety pin hole; the locking lever further comprises a safety pin hole configured to align with the safety pin hole of the handle in the locked position and not align with the safety pin hole of the handle in the unlocked position; and the valve locking mechanism further comprises a safety pin configured to pass through the safety pin hole of the handle and the safety pin hole of the locking lever only in the locked position to lock the locking lever in the locked position.

It is an aspect of the disclosure to provide a valve locking mechanism, wherein the spring is a compression type spring.

It is an aspect of the disclosure to provide a valve locking mechanism, wherein each of the plurality of locking holes has an oval shape.

It is an aspect of the disclosure to provide a valve locking mechanism, wherein the locking stud engages locking holes from a bottom side of the position plate.

It is an aspect of the disclosure to provide a valve locking mechanism, wherein: the locking lever is pivotally connected to the handle by a pivot point, the locking lever arranged on a bottom side of the handle; and in moving from the locked position to the unlocked position, the locking stud moves downward and away from the handle.

It is an aspect of the disclosure to provide a valve locking mechanism, wherein: the locking lever further comprises a grasping portion, the grasping portion configured for a user to grasp to move the locking lever between the locked position and the unlocked position; and in moving from the locked position to the unlocked position, the grasping portion moves upward and toward the handle.

It is an aspect of the disclosure to provide a butterfly valve comprising: a disk configured to rotate about a rotation axis to control a flow of a fluid through a valve body of the butterfly valve; a stem configured to rotate the disk about the rotation axis, the stem connected to the disk and extending along the rotation axis to an outside of the valve body; a valve locking mechanism. The valve locking mechanism comprising: a handle connected to the stem and configured to rotate the stem; a position plate positioned on the rotation axis, the position plate comprising a plurality of locking holes positioned about an outer circumferential edge of the position plate, the plurality of locking holes spaced apart from each other in a rotational direction of the handle, each of the plurality of locking holes completely surrounded by the position plate; a locking lever pivotally connected to the handle about a connection point, the locking lever configured to move between a locked position and an unlocked position, the locking lever including a locking stud mounted to the locking lever, the locking stud proximate to the position plate and configured to engage any one of the plurality of locking holes when the locking lever is in the locked position; and a spring engaging the handle to bias the locking lever toward the locked position in a natural state. When the locking lever is in the locked position, the handle is locked at a rotation position corresponding to the one of the plurality of locking holes engaged by the locking stud.

It is an aspect of the disclosure to provide a butterfly valve, wherein: the handle comprises a safety pin hole; the locking lever further comprises a safety pin hole configured to align with the safety pin hole of the handle in the locked position and not align with the safety pin hole of the handle in the unlocked position; and the valve locking mechanism further comprises a safety pin configured to pass through the safety pin hole of the handle and the safety pin hole of the locking lever only in the locked position to lock the locking lever in the locked position.

It is an aspect of the disclosure to provide a butterfly valve comprising a safety clip attached to the safety pin, the safety clip configured to selectively secure the safety pin in the safety pin hole of the handle.

It is an aspect of the disclosure to provide a butterfly valve, wherein: the position plate further comprises a plurality of connection holes; and the butterfly valve further comprises a plurality of fasteners, the plurality of fasteners configured to pass through the plurality of connection holes, respectively, to mount the position plate to a valve body of the butterfly valve.

It is an aspect of the disclosure to provide valve locking mechanism for a valve having a body defining an axis and a stem rotatable about the axis relative to the body. The valve locking mechanism comprising: a handle configured for attachment to the stem and configured to rotate about the axis; a position plate configured for positioning on the axis and attachment to one of either the handle or the body of the valve, the position plate comprising a plurality of locking holes positioned about an outer circumferential edge of the position plate, the plurality of locking holes spaced apart from each other along a rotational direction of the handle, each of the plurality of locking holes completely surrounded by the position plate; a locking arm mounted to the handle when the position plate is attached to body of the valve or configured for attachment to the body of the valve when the position plate is attached to the handle, the locking arm configured to move between a locked position and an unlocked position, the locking arm including a locking pin configured to engage any one of the plurality of locking holes when the locking arm is in the locked position; and a spring engaged with the locking arm to bias the locking arm toward the locked position in a natural state. When the locking arm is in the locked position, the handle is locked at a rotation position corresponding to the one of the plurality of locking holes engaged by the locking pin.

It is an aspect of the disclosure to provide a valve locking mechanism, wherein: the position plate is attached to the body of the valve; and the locking arm is mounted to the handle.

It is an aspect of the disclosure to provide a valve locking mechanism, wherein: the position plate is attached to the handle; and the locking arm is attached to the body of the valve.

It is an aspect of the disclosure to provide a valve locking mechanism, wherein the spring is a tension type spring.

It is an aspect of the disclosure to provide a valve locking mechanism, wherein: the locking arm is insertably mounted to the handle; and the locking pin is configured to travel in a pin hole of the handle when the locking arm is moved between the locked position and the unlocked position.

It is an aspect of the disclosure to provide a valve locking mechanism, further comprising a locking arm sleeve mounted on the handle around the pin hole, the locking arm sleeve encompassing the spring and at least part of the locking arm, wherein the locking arm further comprises an end plate configured to contact the locking arm sleeve when the locking arm is in the locked position.

It is an aspect of the disclosure to provide a valve locking mechanism, wherein the spring extends from a surface of the handle to a surface of the end plate.

It is an aspect of the disclosure to provide a valve locking mechanism, wherein the locking arm further comprises an outer sleeve extending from a surface of the end plate toward a surface of the handle, the outer sleeve encompassing at least a part of the locking arm sleeve.

It is an aspect of the disclosure to provide a valve locking mechanism, wherein the locking arm is configured to move in a direction parallel to the direction of the axis when moving between the locked position and the unlocked position.

Additional aspects of the disclosure will be set forth in part in the description which follows and, in part, will be obvious from the description, or may be learned by practice of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, he communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1A illustrates a top view of a locking mechanism of the prior art connected to a butterfly valve body assembly;

FIG. 1B illustrates a side view of a locking mechanism of the prior art connected to a butterfly valve body assembly;

FIG. 2A illustrates a top view of a new butterfly valve locking mechanism in accordance with an embodiment connected to a butterfly valve body assembly;

FIG. 2B illustrates a side view of the new butterfly valve locking mechanism in accordance with an embodiment connected to a butterfly valve body assembly;

FIG. 3A illustrates a side view of a locking mechanism in accordance with another embodiment for connection to a butterfly valve body assembly;

FIG. 3B illustrates a perspective view of a locking mechanism in accordance with another embodiment for connection to a butterfly valve body assembly;

FIG. 4A illustrates a top view of a position plate according to an embodiment;

FIG. 4B illustrates a side view of a position plate according to an embodiment;

FIG. 4C illustrates a bottom view of a position plate according to an embodiment;

FIG. 5A illustrates a side view of a handle according to an embodiment;

FIG. 5B illustrates a top view of a handle according to an embodiment;

FIG. 5C illustrates a cross-sectional view of a handle according to an embodiment;

FIG. 5D illustrates a bottom view of a handle according to an embodiment;

FIG. 6A illustrates a bottom view of a locking lever according to an embodiment;

FIG. 6B illustrates a cross-sectional view of a locking lever according to an embodiment;

FIG. 6C illustrates a top view of a locking lever according to an embodiment;

FIG. 6D illustrates a side view of a locking lever according to an embodiment.

FIG. 7A illustrates a side view of a locking mechanism in accordance with another embodiment for connection to a butterfly valve body assembly; and

FIG. 7B illustrates a top view of a locking mechanism in accordance with another embodiment for connection to a butterfly valve body assembly.

### DETAILED DESCRIPTION

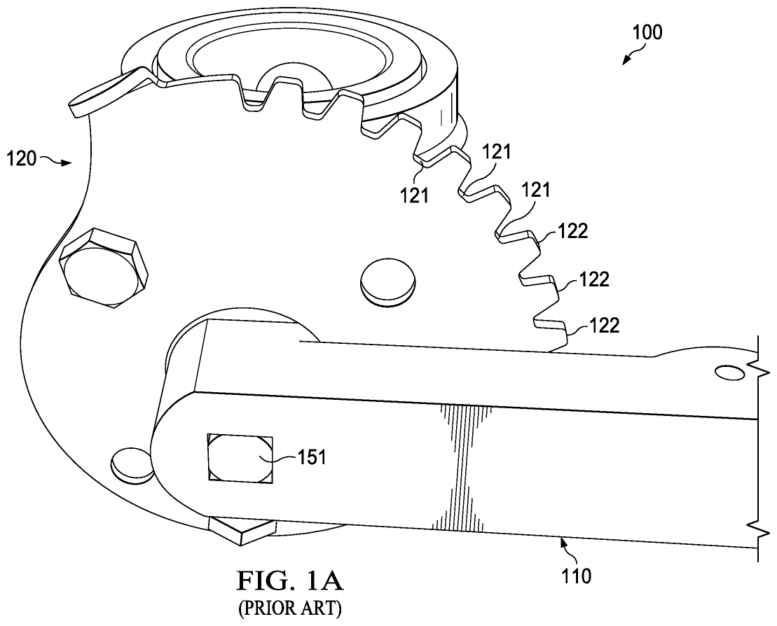

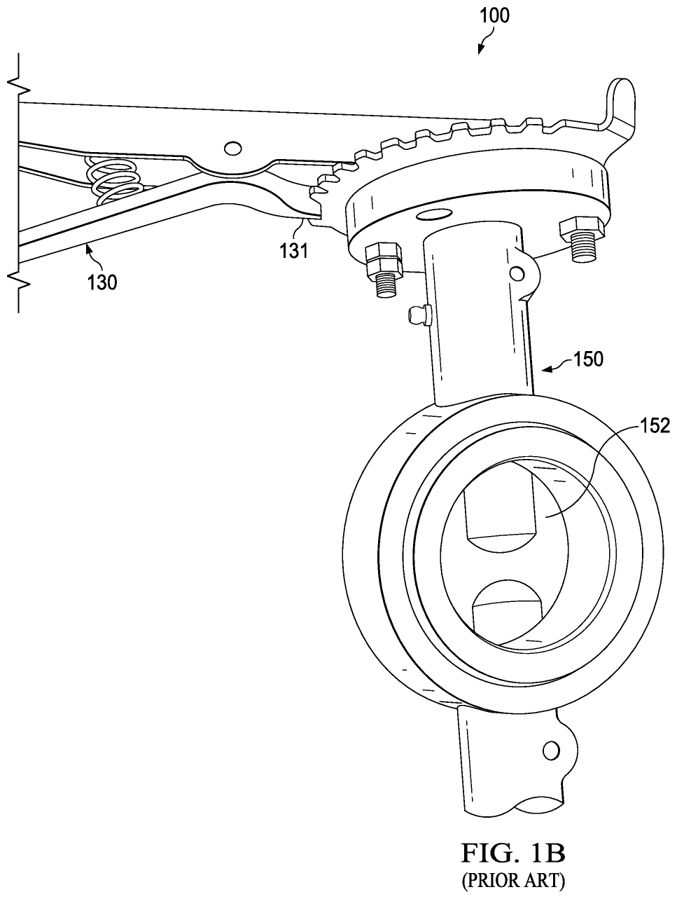

FIGS. 1A through 7B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1A illustrates a top view of a locking mechanism of the prior art connected to a butterfly valve body assembly. FIG. 1B illustrates a side view of a locking mechanism of the prior art connected to a butterfly valve body assembly. Referring to FIGS. 1A and 1B, a locking mechanism of the prior art 100 comprises a handle 110, a position plate 120 and a locking lever 130.

The handle 110 can be rotated by an operator to rotate the stem 151 of the valve body 150 to position of disk 152 in a desired position. The desired position of the disk 152 can be fully opened, closed, or somewhere between full opened and closed. The operator can lock the handle 110 in desired position corresponding to a position of the disk 152 by engaging the locking tooth 131 of the locking lever 130 in a desired locking slot 121 of the position plate 120.

The locking slots 121 are defined by interposed tabs 12.2 formed on the edge of the position plate 120. The tabs 122 are unsupported on the radial outer edge making them susceptible to bending and breakage that can affect the width of the adjacent slots 121.

Hereinafter a locking mechanism according to embodiments of the disclosure will be described in detail with reference to the accompanying drawings.

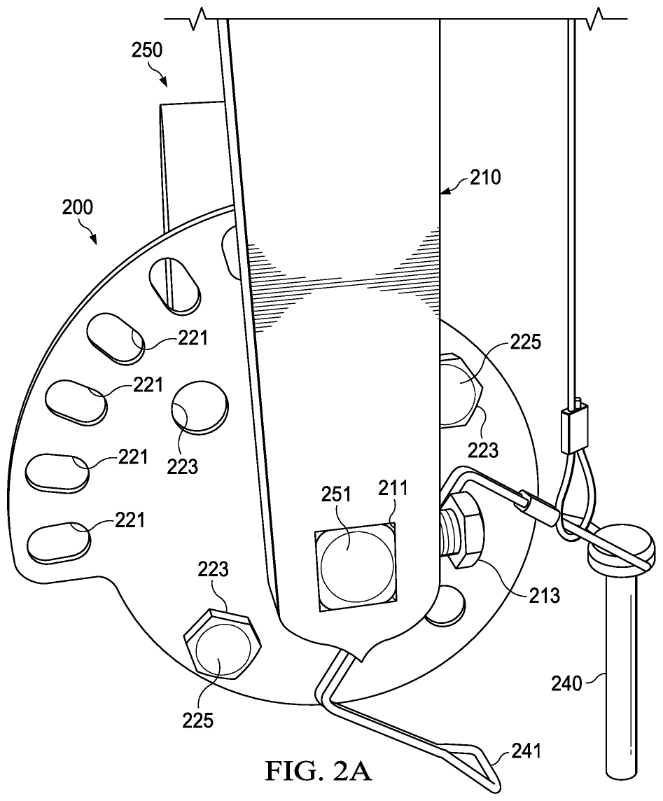

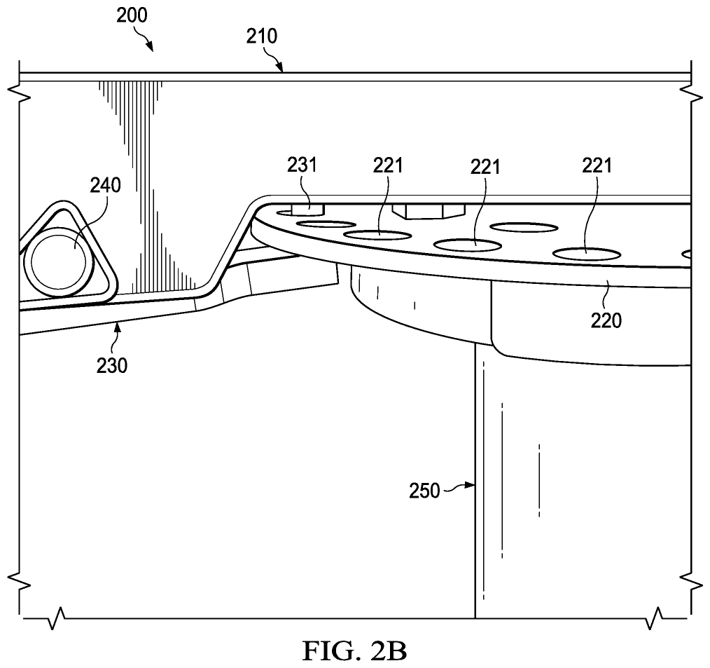

FIG. 2A illustrates a top view of a new butterfly valve locking mechanism in accordance with an embodiment connected to a butterfly valve body assembly. FIG. 2B illustrates a side view of the new butterfly valve locking mechanism in accordance with and embodiment connected to a butterfly valve body assembly. Referring to FIGS. 2A and 2B, a locking mechanism 200 comprises a handle 210, a position plate 220, and a locking lever 230. Except as otherwise described, the butterfly valve body assembly can be substantially identical to that previously described.

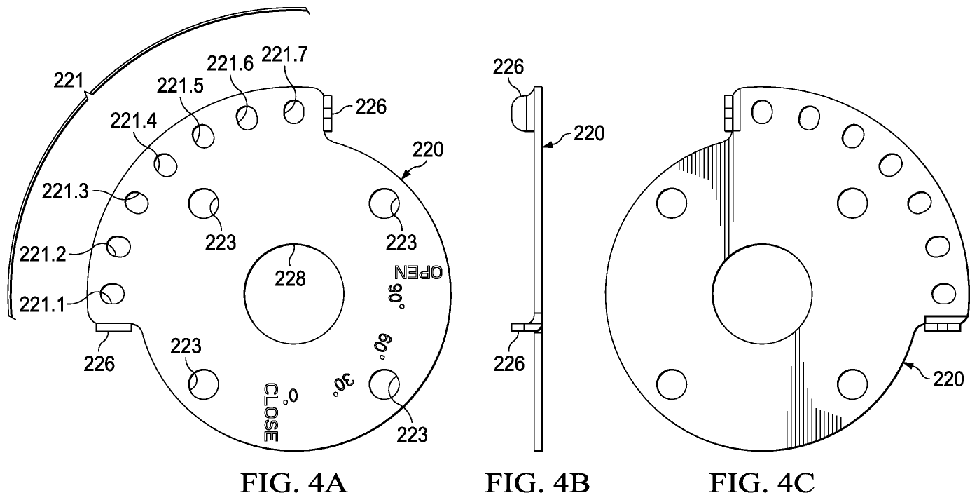

The position plate 220 can be inserted around the stem 251 of the valve body 250 by passing the stem 251 through the stem hole 228 (refer to FIG. 4A). The position plate 220 can be connected to the valve body by connection holes 223. The connection holes 223 can align with matching connection holes of the valve body 250 such that a fastener 225 can be passed through the connection holes 223 to join the position plate 220 and the valve body 250. The position plate can comprise a plurality of locking holes 221.

The handle 210 comprises a stem connection hole 211. The connection hole can be used to connect the handle 210 to the stem 251. The stem 251 can be inserted into the stem connection hole 211. A securing bolt or pin 213 can be used to secure the handle 210 to the stem 251. Through the connection to the stem 251, the handle 210 can be rotated by an operator to rotate the stern 251 and operate the butterfly valve by positioning the disk of the butterfly valve in a desired position. The rotation of handle 210 will be described in greater detail below.

The locking lever 230 is pivotally connected to the handle 210 about the connection point 215. The locking lever 230 may be connected by the connection point 215 to a bottom side of the handle 210. The locking lever 230 comprises a locking stud 231 which can be engaged with the plurality of locking holes 221.

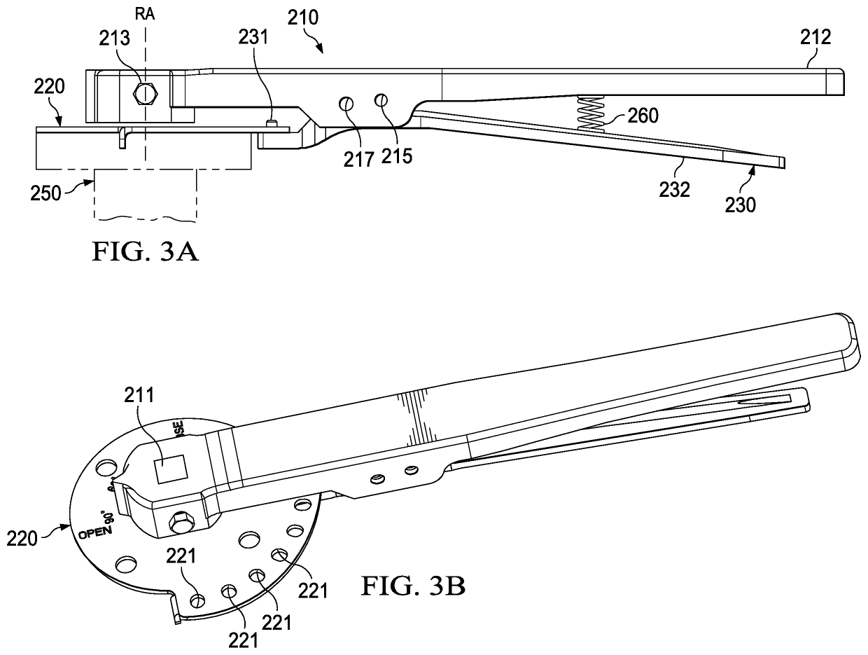

FIG. 3A illustrates a side view of a locking mechanism in accordance with another embodiment for connection to a butterfly valve body assembly. FIG, 3B illustrates a perspective view of a locking mechanism in accordance with another embodiment for connection to a butterfly valve body assembly. Referring to FIGS. 3A-3B, an operation of the locking mechanism 200 will be described.

The locking lever 230 is pivotally connected to the handle 210 by a connection point 215, which can be a hinge pin, bushing, or other pivoting mechanism. The locking lever 230 can pivot about the connection point 215. An operator can pivot the locking lever 230 between a locked and an unlocked position. FIG. 3A illustrates the locking lever 230 in a locked position. The locking lever 230 is locked due to the locking stud 231 being engaged with a locking hole 221 of the position plate 220. The locking stud 231 is engaged with a locking hole 221 when a part of the locking stud 231 passes through the locking hole 221 such that part of the locking stud 231 is surrounded by the locking hole 221. The locking stud 231 can engage the locking hole 221 from a bottom side of the position plate 220. Since the position plate 220 is connected to the valve body 250 and the handle 210 is connected to the valve stem 251, as previously described, the locking stud's 231 engagement with the locking hole 221 prevents an operator from rotating the handle 210 about the rotation axis RA.

A spring 260 can be used to bias the locking lever toward a locked position. The spring 260 can be placed between the handle 210 and locking lever 230 in a compressed state such that spring 260 exerts a force on the handle 210 and the locking lever 230. The connection point 215 about which the locking lever pivots can be between the spring 260 and the locking stud 231. The force exerted by the spring 260 can cause the locking lever 230 to pivot such that the grasping portion 232 of the locking lever 230 is biased away from the grasping portion 212 of the handle 210. Accordingly, since the spring 260 and the locking stud 231 are on opposite sides of the connection point 215, the force exerted by the spring 260 can cause the locking stud 231 to move toward the handle 210 about the connection point 215. In a natural state, due to the force exerted by the spring 260 between the locking lever 230 and the handle 210, the locking lever 230 can be in a locked position. The spring 260 biases the locking lever 230 toward the locked position in a natural state The spring 260 may be a compression type spring.

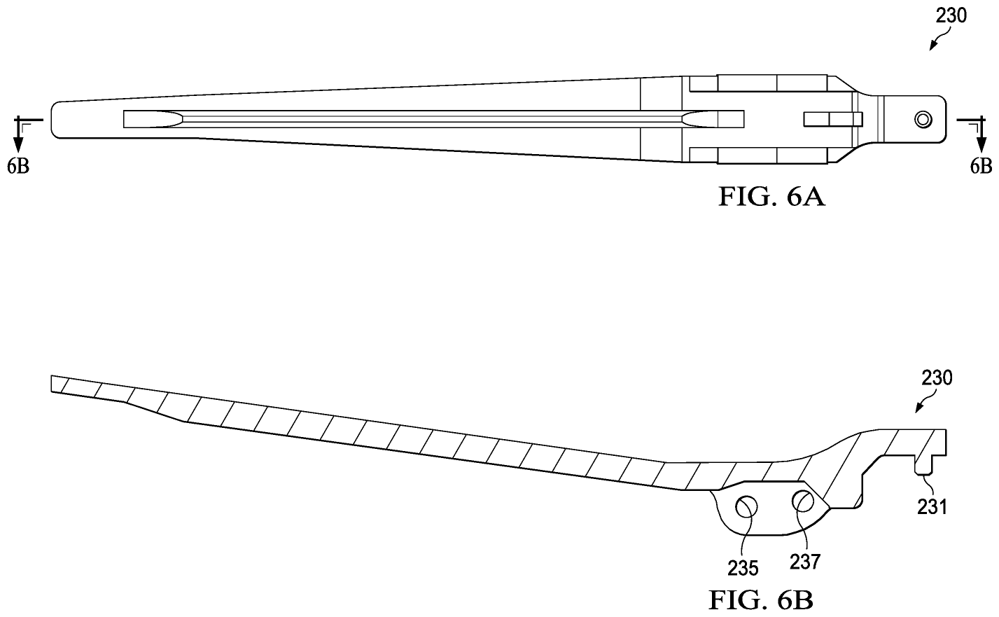

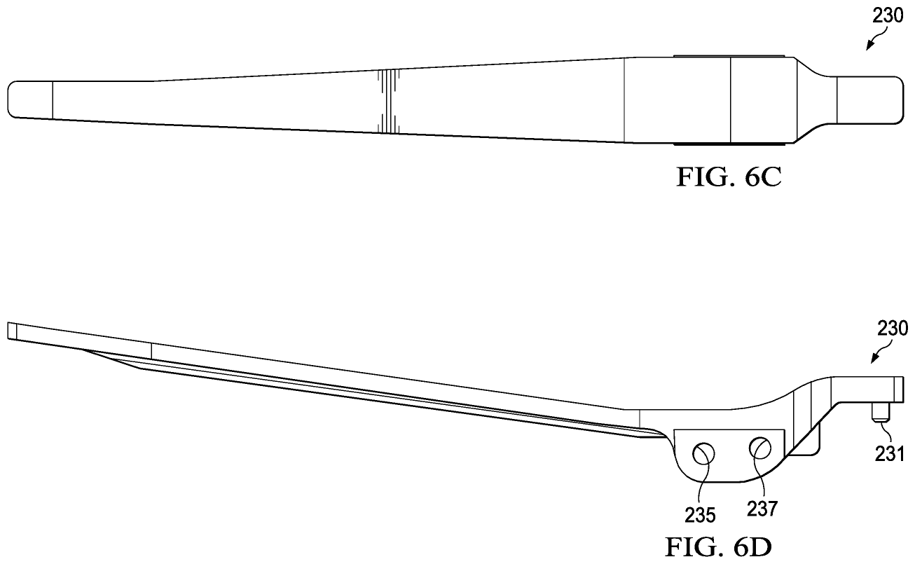

In the locked position, a safety pin holes of the handle 217 and a safety pin hole of the locking lever 237 (refer to FIG. 6D) can be aligned. In the locked position, an operator can pass the safety pin 240 (refer to FIG. 2B) through the safety pin holes of the handle 217 and the locking lever 237 so that the locking lever 230 cannot pivot about the connection point 215 and cannot be changed to an unlocked position. A safety clip 241 can be attached to the safety pin 240 and be configured to selectively secure the safety pin 240 in the safety pin hole of the handle 217. The safety pin hole of the locking lever 237 cannot align with the safety pin hole of the handle 217 in the unlocked position. The safety pin cannot pass through the safety pin holes 217, 237 in the unlocked position.

An operator can move the locking lever 230 from a locked position to an unlocked position. The safety pin 240 can be removed from the safety pin holes of the handle 217 and of the locking lever 237 in order to move the locking lever 230 to the unlocked position. To move the locking lever 230 to the unlocked position, the operator can grasp the grasping portion of the handle 212 and the grasping portion of the lever 232 and squeeze the grasping portions 212, 232 toward each other such that the locking lever 230 pivots about the connection point 215 and grasping portion 232 moves toward the handle grasping portion 212. Accordingly, the pivoting of the locking lever 230 when moving from the locked to the unlocked position can cause the locking stud 231 to move away from the handle 210, since the locking stud 231 and the grasping portion 232 are on opposites sides of the connection point 215 about which the locking lever 230 pivots. In moving from the locked to unlocked position, the locking stud 231 can move downward and away from the handle 210 and the position plate 220. In moving from the locked to unlocked position, the grasping portion 232 can move upward and towards the handle 210. In the unlocked position, the locking stud 231 is disengaged from the locking hole 221, i.e., the locking stud 231 is not surrounded by the locking hole 221.

In the unlocked position, the handle 210 and locking lever 230 can be rotated about the rotation axis RA since the locking stud 231 is not engaged with the locking hole 221. The handle 210 can be rotated, and thus the stem 251 can be rotated, to position the disk of the butterfly valve in a fully open position, a closed position, or anywhere between a fully open position and a closed position.

FIG. 4A illustrates a top view of a position plate 220 according to an embodiment. FIG. 4B illustrates a side view of a position plate 220 according to an embodiment. FIG. 4C illustrates a bottom view of a position plate 220 according to an embodiment. Referring to FIGS. 4A-4C, the position plate 220 will be described in detail.

As previously described, the position plate 220 can include a plurality of connection holes 223 by which fasteners 225 can be used to connect the position plate 22.0 to the valve body 250. The fasteners 225 can pass through the connection holes 223 to connect the position plate 220 to the valve body 250. The position plate 220 can include a stem hole 228 through which the stem 251 of the valve body 250 can pass. The position plate 220 can include a plurality of locking holes 221 that can be engaged by the locking stud 231. The locking holes 221 can be spaced apart from each other about an outer circumferential edge of the position plate 220 in the rotational direction of the handle 210.

The locking holes 221 can be completely surrounded by the position plate 220. The locking holes 221 can have a shape coordinating with an outer perimeter of the locking stud 231 such that the locking stud 231 firmly and securely engages with locking holes 221. For example, as described in FIGS. 4A and 4C, the locking holes 221 can have a generally oval shape to match the generally oval perimeter of the of the locking stud 231. However, various embodiments the locking holes 221 can have different shapes. For example, the locking holes 221 can have a circular, rectangular, or triangular shapes or any other hole shape that is completely surrounded by the position plate 220. Since each locking hole 221 is completely surrounded by portions of the position plate 220, the locking stud 231 can only move into the locking holes 221 from a direction perpendicular to the upper surface of the position plate 220.

The locking holes 221 can be placed around the position plate in locations corresponding to different opening positions of the disk of the valve body. For example, the handle 210 and locking lever 230 can be rotated about the rotation axis .RA such that the locking stud 231 can be engaged with locking hole 221.1. In this position, the example valve disk is fully opened. The handle 210 and locking lever 230 can be rotate about the rotation axis RA 45 degrees such that the locking stud 231 can be engaged with locking hole 221.4. In this position, the example valve disk is half of fully opened. The handle 210 and locking lever 230 can be rotated about the rotation axis RA 90 degrees such that the locking stud 231 can be engaged with locking hole 221.7. In this position, the example valve disk is closed.

As described above and in FIG. 4A, the fully opened position of the valve and the closed position of the valve can be 90 degrees from each other. However, the invention is not limited to a 90-degree range. In other embodiments the range between full open and fully closed can be greater or less than 90 degrees.

The position plate 220 can include stoppers 226. The stoppers 226 can prevent the handle from rotating outside of a region of the position plate 220 containing the locking holes 221. The stoppers 226 can extend in the direction of the rotation axis RA from the position plate 220 toward the valve body 250 to physically contact the locking lever 230 and prevent the handle 210 from being rotated about the rotation axis RA past the stoppers 226. The rotation of the handle 210 can be limited to an area of the position plate 220 defined by the stoppers 226.

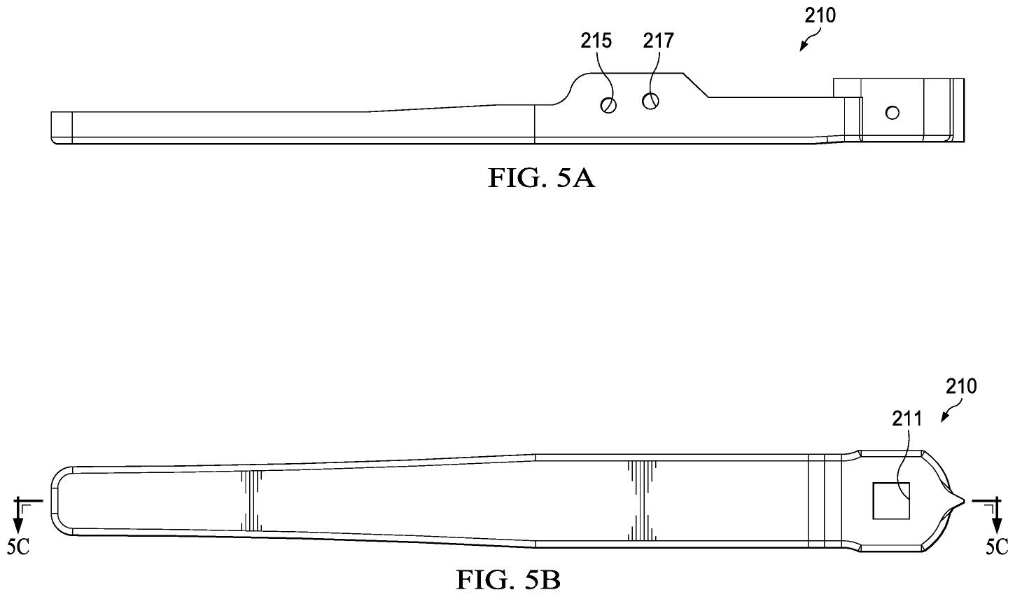

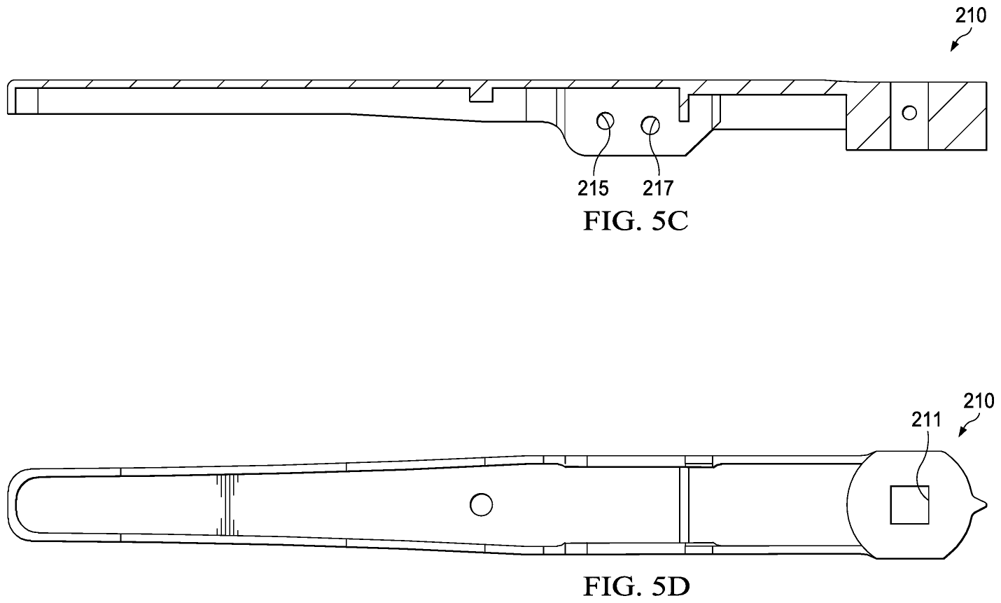

FIG. 5A illustrates a side view of a handle 210 according to an embodiment. FIG. 5B illustrates a top view of a handle 210 according to an embodiment. FIG. 5C illustrates a cross-sectional view of a handle 210 according to an embodiment. FIG. 5D illustrates a bottom view of a handle 210 according to an embodiment. The handle can comprise a stem connection hole 211 by which the handle is connected to the stem 251 of the valve body 250. The handle can comprise a safety pin hole 217 passing through the handle 210. The safety pin hole 217 can align with the safety pin hole 237 of the locking lever 230 when the locking lever is in a locked position so that the safety pin 240 can be inserted to pass through the safety pin holes 217, 237 to lock the locking lever 230 in the locked position. The handle 210 can comprise a connection point 215 about which the handle 210 and locking lever 230 are pivotally connected.

FIG. 6A illustrates a bottom view of a locking lever 230 according to an embodiment. FIG. 6B illustrates a cross-sectional view of a locking lever 230 according to an embodiment. FIG. 6C illustrates a top view of a locking lever 230 according to an embodiment. FIG. 6D illustrates a side view of a locking lever 230 according to an embodiment. The locking lever 230 can include a locking stud 231 for engaging the locking hole 221 of the position plate 220. The locking lever 230 can comprise a safety pin hole 237 which passes through the locking lever 230. When an operator positions the locking lever in the locked position, the safety pin hole 237 can align with the locking hole of the handle 217 so that the operator can pass a safety pin 240 through the safety pin holes 217, 237 to lock the locking lever in the locked position. The safety pin hole of the locking lever 237 cannot align with the safety pin hole of the handle 217 in the unlocked position and thus the safety pin 240 cannot be used to lock locking lever in the unlocked position. The locking lever can comprise a connection point 235 which is joined with the connection point of the handle 215 to pivotally connected the locking lever 230 to the handle 210. The locking lever can comprise a locking stud 231 configured to engage the plurality of locking holes 221 of the position plate 220.

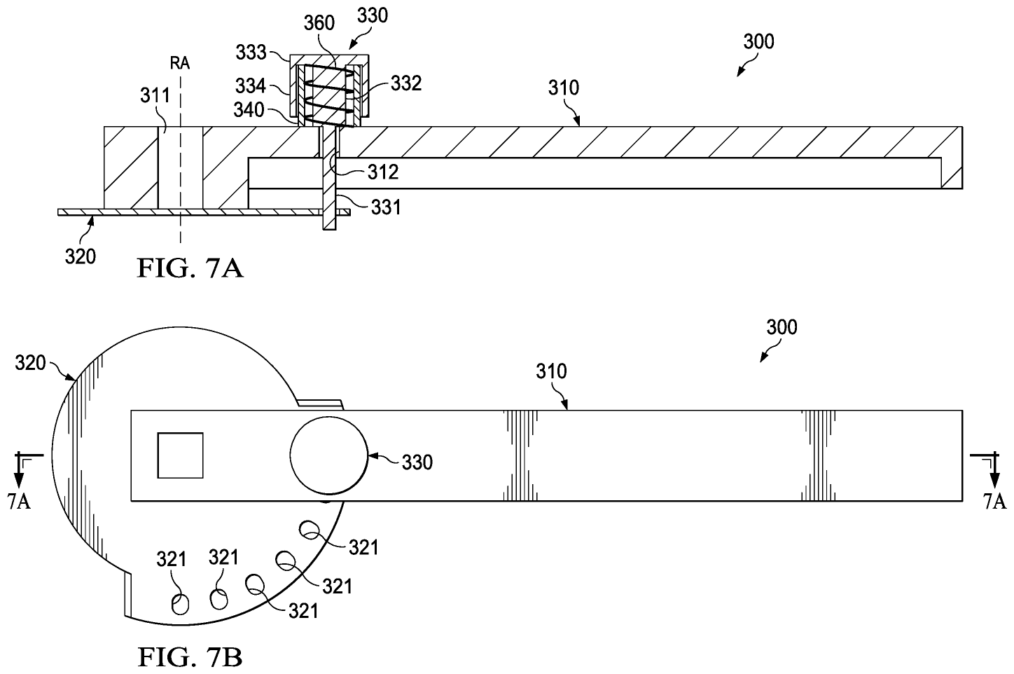

FIG. 7A illustrates a side view of a locking mechanism 300 in accordance with another embodiment for connection to a butterfly valve body assembly. FIG. 7B illustrates a top view of a locking mechanism 300 in accordance with another embodiment for connection to a butterfly valve body assembly. Referring to FIGS. 7A-7B, the locking mechanism comprises a handle 310, a position plate 320, and a locking arm 330.

The position plate 320 is substantially similar to the position plate 220 previously described both in overall structure and in operation. Differences between position plate 320 and position plate 220 will be further described.

The handle 310 comprises a stem connection hole 311. The stem connection hole 311 can be used to connect the handle 310 to the stem 251. Through the connection to the stem 251, the handle 310 can be rotated by an operator to rotate the stem 251 and operate the butterfly valve by positioning the disk of the butterfly valve in a desired position. The handle can comprise a pin hole 312, into which the locking arm 330 may be slidably inserted.

The locking arm 330 is insertably connected to the handle 310 at the pin hole 312 of the handle. The locking arm can comprise a locking arm cylinder 332. The locking arm cylinder 332 can have a diameter greater than a diameter of the pin hole 312 such that a bottom side of the locking arm cylinder may contact a top of the handle 310 without passing through the pin hole 312. The locking arm 330 can comprise a locking pin 331 extending from the bottom side of the cylinder 332. The locking pin 331 can have a diameter less than the diameter of the pin hole 312 so that the locking pin may pass through the pin hole 312. The locking pin 331 can pass through the pin hole 312 and selectively engage the plurality of locking holes 321 of the position plate 320. The locking arm 330 can comprise an end plate 333. The end plate 333 can be mounted to a top side of the cylinder 332. The end plate 333 can have a diameter greater than the diameter of the cylinder 332. The locking arm 330 may comprise an outer sleeve 334 extending from a bottom side of the end plate 333 toward the handle 310. The outer sleeve 334 can have an outer diameter equal to the diameter of the end plate 333. A spring 360 can be provided between the handle 310 and the locking arm 330 to bias the locking arm into an engaged position, as further described.

Referring now to FIGS. 7A-7B, an operation of the locking mechanism 300 will be described. The locking arm 330 is insertably connected to the handle 310 at pin hole 312 of the handle. An operator may move the locking arm 330 between a locked and an unlocked position. FIG. 7A illustrates the locking arm 330 in a locked position. The locking lever is in a locked position when the locking pin 331 is engaged with a locking hole 321 of the position plate 320. The locking pin 331 is engaged with a locking hole 321 when a part of the locking pin 331 passes through the locking hole 321 such that part of the locking pin 331 is surrounded by the position plate 320. The locking pin 331 typically moves perpendicular to the upper surface of the position plate 320 to enter one of the locking holes 321. Since the locking pin 331 is connected to the handle 310 by the locking arm 330, and since the position plate 320 is fixed to the valve body 250, in the locked position the locking pin 331 prevents the handle 310 from rotating about the rotation axis RA. In the locked position, the bottom side of the end plate 333 may contact a top side of a locking arm sleeve 340.

The locking arm 330 is biased to the locked position by spring 360. The spring 360 may extend from a top side of the handle 310 to a bottom side of the end plate 333. The spring 360 can be connected to a top side of the handle 310 and a bottom side of the end plate 333. The spring 360 can be a tension type spring so as to bias the locking arm 330 to the locked position. In other embodiments, a compression type spring can be used to bias the locking arm to the locked position with suitable modifications.

A user may move the locking arm 330 from the locked position to an unlocked position. In the unlocked position the locking pin 331 is disengaged from the locking hole 321. A user may disengage the locking pin 331 from the locking holes 321, and thus move the locking arm 330 to the unlocked position, by moving the end plate 333 and outer sleeve 334 away from the handle in a direction parallel to the direction of the rotation axis RA. Specifically, a user may grasp the outer sleeve 334 and move the locking arm 330 in a direction parallel to the rotation axis RA to move the locking arm 330 into the unlocked position. A user may move the locking arm upward and away from the handle 310 to move the locking arm from the locked to the unlocked position. Because the locking arm 330 is biased to the locked position by spring 360, in moving the locking arm 330 to the unlocked position, an operator must exert enough force to overcome the force exerted on the locking arm 330 by the spring 360. In the unlocked position, since the locking pin 331 is not engaged with any of the locking holes 321, the handle 310 may be rotated freely by a user about the rotation axis RA.

The locking mechanism can comprise a locking arm sleeve 340. The locking arm sleeve can be mounted to a top side of the handle 310 around the pin hole 312. Thus, the locking arm sleeve 340 can have an inner diameter greater than a diameter of the pin hole 312. The locking arm sleeve 340 can encompass the spring 360. The locking arm sleeve 340 can encompass at least a part of the locking arm 330. Specifically, in the locked position, the locking arm sleeve 340 can encompass the locking arm cylinder 332. In the unlocked position, the locking arm sleeve 340 may encompass at least a part of the locking arm cylinder 332 and at least a part of the locking pin 331.

The outer sleeve 334 can extend downward from the end plate 333 to encompass at least a part of the locking arm sleeve 340. Thus, an inner diameter of the outer sleeve 334 can be greater than an outer diameter of the locking arm sleeve 340.

The movement of the locking arm 330 between the locked and unlocked positions may be kept relatively parallel with the rotation axis RA due to the outer sleeve 334 encompassing at least a part of the locking arm sleeve 340. Due to outer sleeve 334 encompassing the locking arm sleeve 340, a user is prevented form substantially moving the locking arm in any direction other than a direction parallel to the rotation axis RA.

Although FIGS. 7A and 7B illustrate the position plate 330 as being attached to a valve body 250 and the locking arm 330 as being mounted to the handle 310, one skilled in the art will recognize that other embodiments are possible. In one alternative embodiment, instead of being attached to the valve body 250, the position plate 320 can be attached to the handle 310 and the locking arm 330 can be mounted to the valve body 250. In such an alternative embodiment, the locking arm 330 can still be configured to selectively engage the plurality of locking holes 321 of the position plate 320. For example, if the position plate 320 is attached to the handle 310, the locking arm may be mounted to valve body 250 below the handle 310. In the locked position, the locking pin 331 can be engaged with one of the plurality of locking holes 321. Because the position plate 320 is attached to the rotatable handle 310, and the locking arm 330 is fixed by being mounted to the valve body 250, the locking pin 331 engaging one of the plurality of locking holes 321 prevents the handle 310 from being able to rotate about the rotation axis RA and locks the handle 310 in a position corresponding to the engaged locking hole 321. To move from the locked to the unlocked position, a user may grasp the outer sleeve 334 to move the locking arm 330 downward and away from the position plate 320 and the handle 310. Because, in this example, the locking arm 330 is mounted below the position plate 320, the downward movement of the locking arm 330 by the user disengages the locking pin 331 from the locking hole 321. Releasing the locking arm 330 allows the locking arm to move back into engagement with a locking hole 321 since the locking arm is biased into the engaged position.

Although the present disclosure has been described with various embodiments, various changes and modifications may be suggested to one skilled in the art. It is intended that the present disclosure encompass such changes and modifications as fall within the scope of the appended claims.

1. A valve locking mechanism, comprising:
a handle configured to rotate about a rotation axis;
a position plate positioned on the rotation axis, the position plate comprising a plurality of locking holes positioned about an outer circumferential edge of the position plate, the plurality of locking holes spaced apart from each other in a rotational direction of the handle, each of the plurality of locking holes completely surrounded by the position plate;
a locking lever pivotally connected to the handle about a connection point, the locking lever configured to move between a locked position and an unlocked position, the locking lever including a locking stud mounted to the locking lever, the locking stud proximate to the position plate and configured to engage any one of the plurality of locking holes when the locking lever is in the locked position; and
a spring engaging the locking lever to bias the locking lever toward the locked position in a natural state,
wherein, when the locking lever is in the locked position, the handle is locked at a rotation position corresponding to the one of the plurality of locking holes engaged by the locking stud.

2. The valve locking mechanism of claim 1, wherein:
the handle comprises a safety pin hole;
the locking lever further comprises a safety pin hole configured to align with the safety pin hole of the handle in the locked position and not align with the safety pin hole of the handle in the unlocked position; and
the valve locking mechanism further comprises a safety pin configured to pass through the safety pin hole of the handle and the safety pin hole of the locking lever only in the locked position to lock the locking lever in the locked position.

3. The valve locking mechanism of claim 1, wherein the spring is a compression type spring.

4. The valve locking mechanism of claim 1, wherein each of the plurality of locking holes has an oval shape.

5. The valve locking mechanism of claim 1, wherein the locking stud engages the locking holes from a bottom side of the position plate.

6. The valve locking mechanism of claim 1, wherein:
the locking lever is pivotally connected to the handle by a pivot point, the locking lever arranged on a bottom side of the handle; and
in moving from the locked position to the unlocked position, the locking stud moves downward and away from the handle.

7. The valve locking mechanism of claim 6, wherein:
the locking lever further comprises a grasping portion, the grasping portion configured for a user to grasp to move the locking lever between the locked position and the unlocked position; and
in moving from the locked position to the unlocked position, the grasping portion moves upward and toward the handle.

8. A butterfly valve comprising:
a disk configured to rotate about a rotation axis to control a flow of a fluid through a valve body of the butterfly valve;
a stem configured to rotate the disk about the rotation axis, the stem connected to the disk and extending along the rotation axis to an outside of the valve body;
a valve locking mechanism, comprising:
a handle connected to the stem and configured to rotate the stem;
a position plate positioned on the rotation axis, the position plate comprising a plurality of locking holes positioned about an outer circumferential edge of the position plate, the plurality of locking holes spaced apart from each other in a rotational direction of the handle, each of the plurality of locking holes completely surrounded by the position plate;
a locking lever pivotally connected to the handle about a connection point, the locking lever configured to move between a locked position and an unlocked position, the locking lever including a locking stud mounted to the locking lever, the locking stud proximate to the position plate and configured to engage any one of the plurality of locking holes when the locking lever is in the locked position; and
a spring engaging the handle to bias the locking lever toward the locked position in a natural state,
wherein, when the locking lever is in the locked position, the handle is locked at a rotation position corresponding to the one of the plurality of locking holes engaged by the locking stud.

9. The butterfly valve of claim 8, wherein:
the position plate further comprises a plurality of connection holes; and
the butterfly valve further comprises a plurality of fasteners, the plurality of fasteners configured to pass through the plurality of connection holes, respectively, to mount the position plate to a valve body of the butterfly valve.

10. The butterfly valve of claim 8, wherein:
the handle comprises a safety pin hole;
the locking lever further comprises a safety pin hole configured to align with the safety pin hole of the handle in the locked position and not align with the safety pin hole of the handle in the unlocked position; and
the valve locking mechanism further comprises a safety pin configured to pass through the safety pin hole of the handle and the safety pin hole of the locking lever only in the locked position to lock the locking lever in the locked position.

11. The butterfly valve of claim 10, further comprising a safety clip attached to the safety pin, the safety clip being configured to selectively secure the safety pin in the safety pin hole of the handle.

12. A valve locking mechanism for a valve having a body defining an axis and a stem rotatable about the axis relative to the body, the valve locking mechanism comprising:
a handle configured for attachment to the stem and configured to rotate about the axis;
a position plate configured for positioning on the axis and attachment to one of either the handle or the body of the valve, the position plate comprising a plurality of locking holes positioned about an outer circumferential edge of the position plate, the plurality of locking holes spaced apart from each other along a rotational direction of the handle, each of the plurality of locking holes completely surrounded by the position plate;
a locking arm mounted to the handle when the position plate is attached to body of the valve or configured for attachment to the body of the valve when the position plate is attached to the handle, the locking arm configured to move between a locked position and an unlocked position, the locking arm including a locking pin configured to engage any one of the plurality of locking holes when the locking arm is in the locked position; and
a spring engaged with the locking arm to bias the locking arm toward the locked position in a natural state,
wherein, when the locking arm is in the locked position, the handle is locked at a rotation position corresponding to the one of the plurality of locking holes engaged by the locking pin.

13. The valve locking mechanism of claim 12, wherein:
the position plate is attached to the body of the valve; and
the locking arm is mounted to the handle.

14. The valve locking mechanism of claim 12, wherein:
the position plate is attached to the handle; and
the locking arm is attached to the body of the valve.

15. The valve locking mechanism of claim 12, wherein the spring is a tension type spring.

16. The valve locking mechanism of claim 13, wherein:
the locking arm is insertably mounted to the handle; and
the locking pin is configured to travel in a pin hole of the handle when the locking arm is moved between the locked position and the unlocked position.

17. The valve locking mechanism of claim 16, further comprising a locking arm sleeve mounted on the handle around the pin hole, the locking arm sleeve encompassing the spring and at least part of the locking arm,
wherein the locking arm further comprises an end plate configured to contact the locking arm sleeve when the locking arm is in the locked position.

18. The valve locking mechanism of claim 17, wherein the spring extends from a surface of the handle to a surface of the end plate.

19. The valve locking mechanism of claim 17, wherein the locking arm further comprises an outer sleeve extending from a surface of the end plate toward a surface of the handle, the outer sleeve encompassing at least a part of the locking arm sleeve.

20. The valve locking mechanism of claim 12, wherein the locking arm is configured to move in a direction parallel to the direction of the axis when moving between the locked position and the unlocked position.
